(19) United States
(12) Patent Application Publication
(10) Pub. No.: US 2013/0290169 A1
(43) Pub. Date: Oct. 31, 2013

(54) MANAGING FINANCIAL TRANSACTIONS USING TRANSACTION DATA FROM SMS NOTIFICATIONS

(71) Applicants: Venkata Naresh Bathula, Nellore (IN); Sanjay Kumar, Bangalore (IN); Raju V. S. S. Vusirikala, Bangalore (IN); Smita Shankar, Bangalore (IN); Sunil H. Madhani, Mumbai (IN)

(72) Inventors: Venkata Naresh Bathula, Nellore (IN); Sanjay Kumar, Bangalore (IN); Raju V. S. S. Vusirikala, Bangalore (IN); Smita Shankar, Bangalore (IN); Sunil H. Madhani, Mumbai (IN)

(73) Assignee: INTUIT INC., Mountain View, CA (US)

(21) Appl. No.: 13/456,029

(22) Filed: Apr. 25, 2012

(51) Int. Cl. G06Q 20/08; H04W 4/14

(52) U.S. Cl. 705/39

(57) ABSTRACT

The disclosed embodiments provide a system that facilitates management of a financial transaction. During operation, the system obtains transaction data for the financial transaction between a user and an organization from a Short Message Service (SMS) notification on an electronic device of the user. Next, the system determines a category of the financial transaction based on the transaction data. The system also displays the transaction data and the category on the electronic device. Finally, the system uses the displayed transaction data and the displayed category to enable, for the user, management of the financial transaction without accessing the transaction data at the organization.

### BACKGROUND

### Related Art

The disclosed embodiments relate to techniques for managing financial transactions for users. More specifically, the disclosed embodiments relate to techniques for managing financial transactions using transaction data from Short Message Service (SMS) notifications.

Financial institutions often provide websites that enable their customers to access account information online. Moreover, most people have accounts at a number of different financial institutions. For example, a person might have: (1) bank accounts at a bank, (2) credit card accounts with different credit card issuers, and (3) investment accounts with different brokerage firms. This means that the person must visit a number of different websites belonging to different financial institutions to determine their financial position accurately, which is a cumbersome and time-consuming process.

To speed up this process, an “account aggregation” system may automatically compile information from different accounts. During initial use of an account aggregation system, a user may provide account credentials (such as usernames and passwords) for accounts with various financial institutions. The account aggregation system may use the account credentials to access the accounts online, retrieve transactions and/or other data associated with the accounts, and compile the retrieved information into a list, table, chart, graph, and/or other representation that can be viewed and/or understood by the user. The account aggregation system may additionally reside within a web application, a mobile application, and/or a network-enabled client application.

However, account aggregation systems may be associated with a number of limitations. First, use of the account aggregation systems may be limited by a user's willingness to provide account credentials to the aggregation systems and/or the user's ability to access the Internet. For example, a user may choose to not use an account aggregation system because the user finds the risk associated with providing sensitive account credentials to a third party to be unacceptably high. On the other hand, the user may effectively be prevented from using the account aggregation system if the user's electronic device (e.g., mobile phone) lacks Internet connectivity.

Second, account aggregation systems may lack the ability to update account information in real-time. For example, the account aggregation systems may lack the ability to detect updates to account balances and/or transactions from the financial institutions. Instead, the account aggregation systems may periodically pull account information (e.g., every 24 hours, upon user request, etc.) from the websites of the financial institutions. Such delays in account updates coupled with limited Internet access may negatively impact users' management of finances using the account aggregation systems. Consequently, use of account aggregation systems may be facilitated by techniques for securing and/or improving access to up-to-date account information for users of the account aggregation systems.

### SUMMARY

The disclosed embodiments provide a system that facilitates management of a financial transaction. During operation, the system obtains transaction data for the financial transaction between a user and an organization from a Short Message Service (SMS) notification on an electronic device of the user. Next, the system determines a category of the financial transaction based on the transaction data. The system also displays the transaction data and the category on the electronic device. Finally, the system uses the displayed transaction data and the displayed category to enable, for the user, management of the financial transaction without accessing the transaction data at the organization.

In some embodiments, obtaining the transaction data for the transaction from the SMS notification involves scraping the transaction data from the SMS notification.

In some embodiments, the transaction data is obtained upon detecting a delivery of the SMS notification to the electronic device.

In some embodiments, determining the category of the financial transaction based on the transaction data involves using a sender identifier from the SMS notification to identify the organization as a sender of the SMS notification, and identifying the category using the organization and one or more keywords in the SMS notification.

In some embodiments, the sender identifier includes an access provider code, a service area code, and an organization identifier.

In some embodiments, the transaction data and the category are displayed to the user using at least one of a list, a chart, a table, and a graphic.

In some embodiments, using the displayed transaction data and the displayed category to enable, for the user, management of the financial transaction involves at least one of:
(i) providing a reminder associated with the financial transaction to the user;
(ii) providing a balance associated with the financial transaction and other financial transactions between the user and one or more organizations comprising the organization;
(iii) enabling contact between the user and a financial institution associated with the financial transaction;
(iv) providing an account history associated with the financial transaction and the other financial transactions; and
(v) enabling tracking of a budget based on the transaction and the other transactions.

In some embodiments, the transaction is at least one of a completed transaction and an upcoming transaction.

### BRIEF DESCRIPTION OF THE FIGURES

FIG. 1 shows a schematic of a system in accordance with the disclosed embodiments.

FIG. 2 shows an exemplary screenshot in accordance with the disclosed embodiments.

FIG. 3 shows an exemplary screenshot in accordance with the disclosed embodiments.

FIG. 4 shows a flowchart illustrating the process of facilitating management of a financial transaction in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for processing data. The data may correspond to transaction data for financial transactions between a user and one or more organizations. For example, the data may describe completed transactions and/or upcoming financial transactions between the user and a financial institution, credit card issuer, insurance company, transport-service organization (e.g., airline, bus company, railway company), educational institution, and/or event-management organization (e.g., ticket sales company).

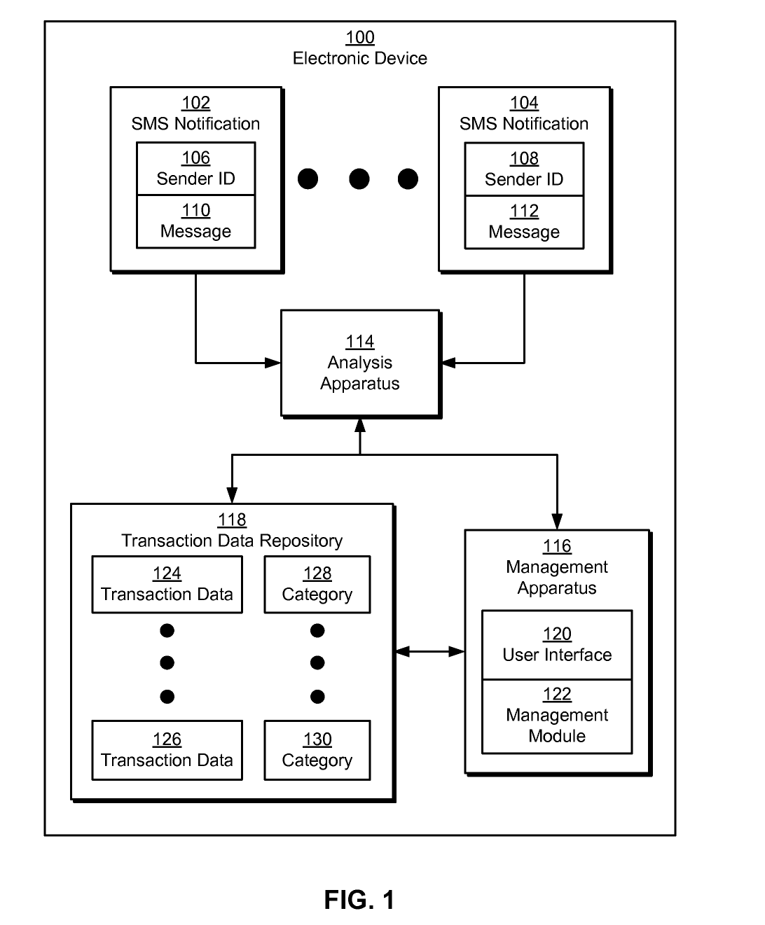

More specifically, the disclosed embodiments provide a method and system for facilitating management of the financial transactions using transaction data from Short Message Service (SMS) notifications. As shown in FIG. 1, a set of SMS notifications 102-104 may be received by an electronic device 100, such as a mobile phone, tablet computer, laptop computer, personal digital assistant (PDA), and/or other SMS-enabled electronic device.

SMS notifications 102-104 may contain transaction data 124-126 for one or more financial transactions between a user of electronic device 100 and one or more organizations. For example, SMS notifications 102-104 may be sent by the organizations to electronic device 100 to inform the user of recently completed financial transactions (e.g., credits, debits, purchases, refunds, etc.) and/or remind the user of upcoming financial transactions (e.g., bill payments, events, flights, train departures, etc.). As a result, messages 110-112 in SMS notifications 102-104 may include details of the financial transactions, such as transaction dates, transaction amounts, transaction types, accounts associated with the financial transactions, tickets (e.g., plane tickets, train tickets, event tickets, etc.) associated with the financial transactions, and/or balances associated with the financial transactions.

Because SMS notifications 102-104 may be transmitted through widely available communications systems (e.g., cellular networks) with little impact to the communications systems, SMS notifications 102-104 may be used as reliable, cheap, lightweight, timely, and/or accessible mechanisms for alerting and/or notifying the user of the financial transactions. For example, each SMS notification 102-104 may be received by the user a few seconds to a few minutes after the corresponding financial transaction has been scheduled and/or completed to confirm the transaction with the user and/or allow the user to detect fraudulent financial transactions. SMS notifications 102-104 may further be received by electronic device 100 and/or the user in the absence of Internet connectivity that is normally required for the user to access his/her accounts and/or financial transactions with the organizations from electronic device 100.

In one or more embodiments, the system of FIG. 1 includes functionality to enable, for the user, management of the user's financial transactions and/or accounts with the organizations without accessing the financial transactions and/or accounts at the organizations. For example, electronic device 100 may allow the user to manage his/her personal finances, insurance payments, scheduled transportation, and/or scheduled events without connecting to servers and/or obtaining account credentials for online access to the user's accounts with the organizations.

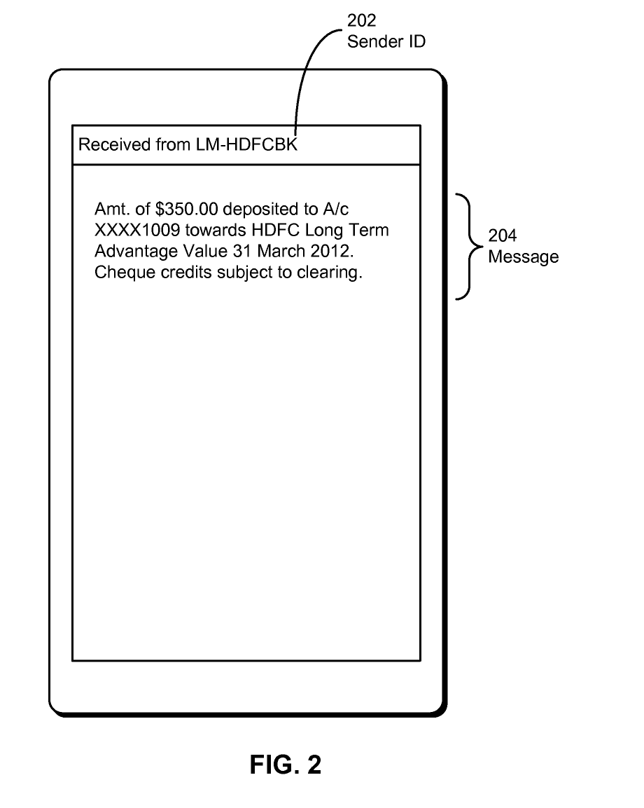

More specifically, an analysis apparatus 114 on electronic device 100 may obtain transaction data 124-126 for the financial transactions from SMS notifications 102-104. For example, analysis apparatus 114 may scrape transaction data (e.g., transaction data 124-126) for each financial transaction from the corresponding SMS notification 102-104. Scraping of transaction data from SMS notifications is discussed in further detail below with respect to FIG. 2.

Next, analysis apparatus 114 may determine a category 128-130 of the financial transaction based on the transaction data. As shown in FIG. 1, each SMS notification 102-104 may include a sender identifier (ID) 106-108 such as a phone number, short code, and/or other alphanumeric ID for an organization from which the SMS notification was received. In turn, sender IDs 106-108 may allow analysis apparatus 114 to identify the organization as the sender of the SMS notification. For example, analysis apparatus 114 may maintain a table and/or other data structure that maps sender IDs 106-108 to organizations associated with sender IDs 106-108.

In one or more embodiments, sender IDs 106-108 conform to a standardized format for SMS notifications 102-104 from certain types of organizations. For example, sender IDs 106-108 from banks, financial institutions, insurance companies, credit card issuers, railway companies, airlines, and/or educational institutions may be formatted as “XY-ABCDEF”, with “X” corresponding to an access provider code, “Y” corresponding to a service area code, and “ABCDEF” identifying the organization from which the corresponding SMS notification 102-104 was received. As a result, analysis apparatus 114 may identify the organizations by matching the last six characters of sender IDs 106-108 with organizations represented by the characters.

Analysis apparatus 114 may use the identified organization and one or more keywords in the SMS notification to identify the category of the financial transaction. For example, analysis apparatus 114 may identify the sender of the SMS notification as a financial institution and use keywords such as “account,” “balance,” “deposit,” and/or “withdrawal” in the scraped transaction data from the SMS notification to categorize the financial transaction as a deposit, withdrawal, and/or balance inquiry by the user with the financial institution. Analysis apparatus 114 may also store the scraped transaction data, category, and/or SMS notification in a transaction data repository 118 for subsequent retrieval and/or use by other components in electronic device 100.

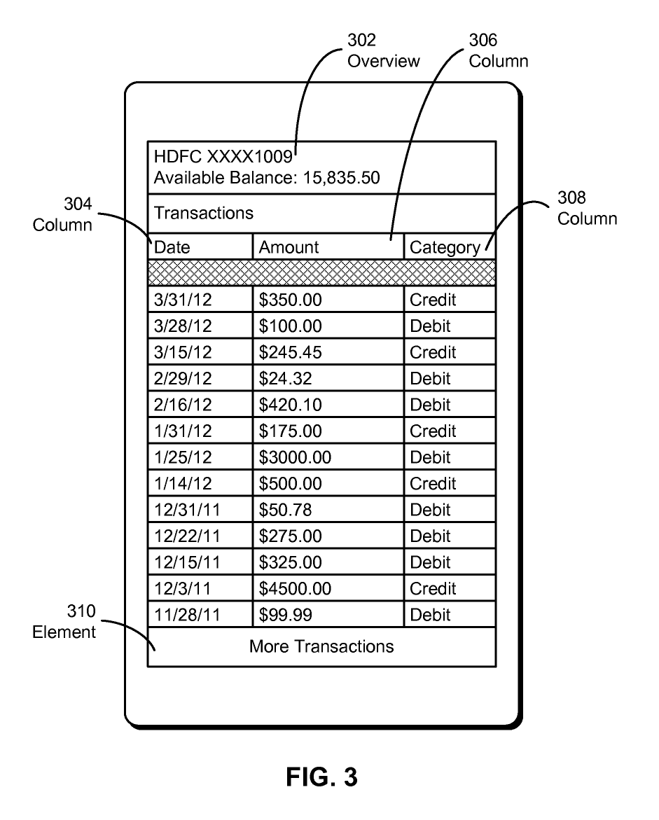

After transaction data repository 118 is updated with a new set of transaction data and a category for the transaction data, a management apparatus 116 in electronic device 100 may display the transaction data and category to the user of electronic device 100. In particular, management apparatus 116 may provide a user interface 120 (e.g., graphical user interface) within which the transaction data and category are displayed. In addition, management apparatus 116 may display the transaction data and category using a number of graphical and/or user interface elements, including lists, charts, tables, and/or graphics. Displaying of transaction data and categories of financial transactions is discussed in further detail below with respect to FIG. 3.

Management apparatus 116 may additionally use the displayed transaction data and/or category to enable management of the transaction by the user without accessing the transaction data at the organization. Management apparatus 116 may provide a management module 122 with which the user may interact through user interface 120. To manage the transaction using management apparatus 116, the user may configure management module 122 to provide a reminder associated with the transaction to the user. For example, the user may use management module 122 to set an alarm and/or pop-up to occur a pre-specified period before a bill is due, an insurance payment is late, and/or a flight is scheduled to occur.

Management module 122 may also provide a balance associated with the financial transaction and/or other financial transactions between the user and the organization(s). For example, management module 122 may calculate a balance for the user's bank account based on transaction data 124-126 specifying the deposits and withdrawals for the bank account. Alternatively, management module 122 may obtain the balance directly from transaction data 124-126 if SMS notifications associated with the bank account provide a running balance for the bank account.

Management module 122 may additionally enable contact between the user and a financial institution associated with the financial transaction. For example, management module 122 may provide a phone number and/or email address for the financial institution to the user to allow the user to contact the financial institution about a fraudulent transaction, an error in the financial transaction, and/or other issues associated with the financial transaction and/or other financial transactions.

Management module 122 may further facilitate management of financial transactions for the user by providing an account history associated with the financial transaction(s). For example, management module 122 may display a list of financial transactions for a particular account and/or organization and allow the user to view transaction data for a specific transaction by selecting the transaction within the list. Management module 122 may also allow the user to search for financial transactions by keyword, date range, amount, category, and/or other criteria.

Finally, management module 122 may enable tracking of a budget based on the financial transaction(s). For example, management module 122 may allocate a budget to the user based on transaction data 124-126 and/or obtain a budget from the user. Management module 122 may subsequently use transaction data 124-126 and categories 128-130 to track the user's adherence to the budget based on the user's purchases, savings, and/or other expenses. Management module 122 may further generate alerts (e.g., through user interface 120) if the user approaches and/or exceeds the budget.

By obtaining transaction data 124-126 from SMS notifications 102-104, categorizing transaction data 124-126, and enabling management of financial transactions using transaction data 124-126 and categories 128-130, the system of FIG. 1 may facilitate personal financial management for the user without requiring Internet connectivity on electronic device 100 and/or sensitive account credentials for user accounts associated with the financial transactions. For example, analysis apparatus 114 and management apparatus 116 may be used by the user as long as electronic device 100 is SMS-enabled and/or the organizations are configured to deliver SMS notifications for the user's accounts to electronic device 100. Moreover, because SMS notifications 102-104 may be received shortly after the corresponding financial transactions are scheduled and/or completed, analysis apparatus 114 and management apparatus 116 may provide a more up-to-date representation of the user's financial transactions and/or accounts than a conventional financial management tool that periodically obtains updates to the user's accounts and/or financial transactions from the organizations.

Those skilled in the art will appreciate that the system of FIG. 1 may be implemented in a variety of ways. More specifically, analysis apparatus 114 and management apparatus 116 may be provided by the same software and/or hardware component, or analysis apparatus 114 and management apparatus 116 may execute independently from one another. For example, analysis apparatus 114 and management apparatus 116 may be implemented using different combinations of a general-purpose processor, a special-purpose processor, an operating system kernel, a standalone application, and/or a driver on electronic device 100. Analysis apparatus 114 and/or management apparatus 116 may also reside outside electronic device 100. For example, some or all of analysis apparatus 114 and/or management apparatus 116 may execute on a Short Message Service Center (SMSC) and/or other cellular network element that relays and/or intercepts SMS notifications 102-104 from the organizations to electronic device 100.

FIG. 2 shows an exemplary screenshot in accordance with the disclosed embodiments. More specifically, FIG. 2 shows a screenshot of an SMS notification on an electronic device, such as electronic device 100 of FIG. 1. The SMS notification includes a sender ID 202 and a message 204.

As mentioned above, sender ID 202 may be used to identify an organization as a sender of the SMS notification. Moreover, sender ID 202 may conform to a standardized format for SMS notifications from financial institutions, credit card issuers, banks, insurance companies, airlines, railway companies, educational institutions, and/or other types of organizations.

As shown in FIG. 2, sender ID 202 is nine characters long, with the first two characters (e.g., “LM”) separated from the last six characters (e.g., “HDFCBK”) by a dash. The first character (e.g., “L”) may be an access provider code that represents an entity responsible for transmitting the SMS notification, such as a telecommunications company. The second character (e.g., “M”) may be a service area code that denotes the area from which the SMS notification was transmitted. Finally, the last six characters (e.g., “HDFCBK”) may be an organization ID of the organization from which the SMS notification was received. The format of sender ID 202 may thus enable identification of both the organization as the sender of the SMS notification and the SMS notification as containing transaction data for a financial transaction between a user of the electronic device and the organization.

Details of the financial transaction may also be obtained as transaction data from message 204. For example, message 204 may be scraped to obtain account details of “XXXX1009” and “HDFC Long Term Advantage Value” and transaction details of “$350 deposited” and “31 Mar. 2012” for the financial transaction.

The transaction data may also be used to determine a category of the financial transaction. For example, the organization identified from sender ID 202 may represent a financial institution named “HDFC,” and the account details from the transaction data may indicate that the financial transaction is a deposit to an account with the financial institution. As a result, the financial transaction may be categorized as a deposit to the user's account ending in 1009 with a financial institution named “HDFC.” The transaction data and category may then be used to facilitate management of the financial transaction by the user, as discussed below with respect to FIG. 3.

FIG. 3 shows an exemplary screenshot in accordance with the disclosed embodiments. More specifically, FIG. 3 shows a screenshot of a user interface (e.g., user interface 120 of FIG. 1) on an electronic device for managing financial transactions between a user and one or more organizations. The user interface includes an overview 302 associated with the transaction data and categories, as well as a table containing a set of columns 304-308 displaying transaction data for the financial transactions.

Overview 302 may include a bank account (e.g., “HDFC) XXXX1009”) associated with the financial transactions and an available balance (e.g., “15,835.50”) for the bank account. Column 304 (e.g., “Date”) may include a set of dates for the financial transactions, column 306 (e.g., “Amount”) may specify a set of amounts associated with the financial transactions, and column 308 (e.g., “Category”) may contain categories for the financial transactions. In other words, overview 302 and columns 304-308 may provide a user of the electronic device with account details, an account balance, and an account history of the account.

The user may use the displayed information to manage the account and/or financial transactions. For example, the user may select an element 310 (e.g., “More Transactions”) of the user interface to view additional financial transactions associated with the account and/or search for financial transactions by date range, amount, category, and/or keyword. The user may also select a row in the table to view additional details of the corresponding financial transaction, update a budget using the financial transaction, flag the financial transaction as fraudulent, and/or modify the transaction details or delete the financial transaction if the displayed details are incorrect. Likewise, the user may manually add financial transactions to the account and/or modify the available balance in overview 302 if the displayed transaction data is incomplete and/or inaccurate. Finally, the user may navigate to other screens of the user interface to view lists, charts, tables, and/or graphics containing transaction data (e.g., transaction details, upcoming financial transactions, plane tickets, event tickets, etc.) for other accounts and/or aggregate data for all accounts; schedule reminders associated with the financial transactions; and/or manage and/or track budgets using the accounts and/or financial transactions.

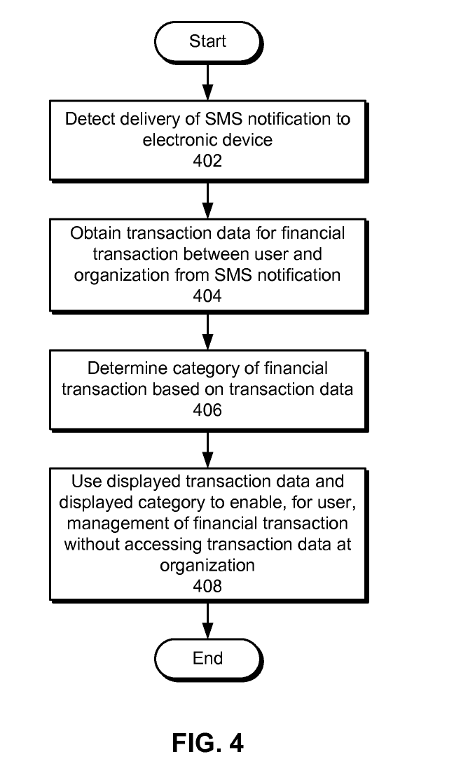

FIG. 4 shows a flowchart illustrating the process of processing data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, delivery of an SMS notification to an electronic device is detected (operation 402). The delivery of the SMS notification may be detected by an operating system and/or application on the electronic device. Next, transaction data for a financial transaction between the user and an organization is obtained from the SMS notification (operation 404). For example, the transaction data may describe an upcoming or completed purchase of goods or services, bill payment, account deposit, account withdrawal, insurance payment, and/or balance inquiry. The transaction data may be scraped from the SMS notification.

A category of the financial transaction is also determined based on the transaction data (operation 406). A sender ID from the SMS notification may be used to identify the organization as a sender of the SMS notification. For example, the sender ID may include an access provider, a service area code, and/or an organization ID. The organization ID may be matched to the organization using a table and/or other data structure containing organization names and organization IDs. The organization and one or more keywords in the SMS notification may then be used to identify the category of the transaction.

Finally, the displayed transaction data and displayed category are used to enable, for the user, management of the financial transaction without accessing the transaction data at the organization (operation 408). For example, management of the financial transaction by the user may be facilitated by providing a reminder associated with the transaction to the user, providing a balance associated with the financial transaction and other financial transactions between the user and one or more organizations, enabling contact between the user and a financial institution associated with the financial transaction, providing an account history associated with the financial transactions, and/or enabling tracking of a budget based on the financial transactions.

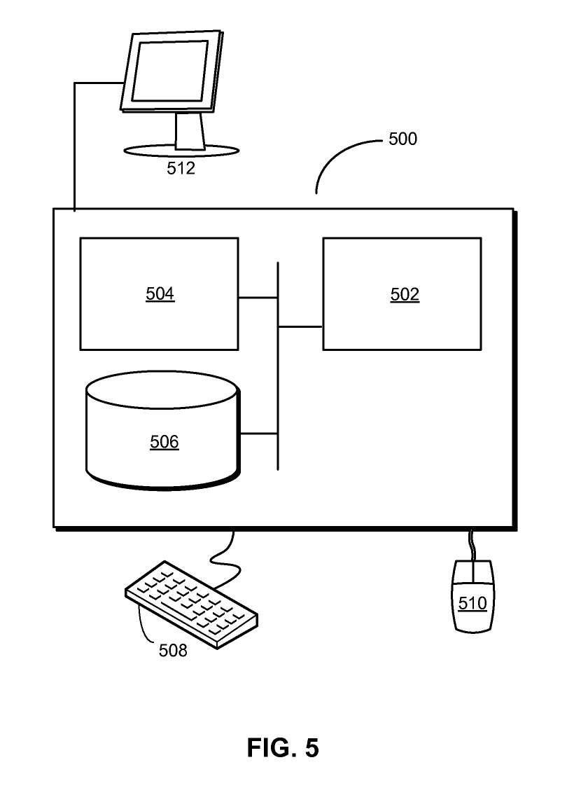

FIG. 5 shows a computer system 500 in accordance with an embodiment. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an analysis apparatus that obtains transaction data for a financial transaction between a user and an organization from an SMS notification on an electronic device of the user and determines a category of the financial transaction based on the transaction data.

The system may also include a management apparatus that displays the transaction data and the category on the electronic device and uses the displayed transaction data and the displayed category to enable, for the user, management of the financial transaction without accessing the transaction data at the organization.

In addition, one or more components of computer system 500 may be remotely located and connected to the other components over a network. Portions of the present embodiments (e.g., analysis apparatus, management apparatus, etc.) may also be located on different nodes of a distributed system that implements the embodiments. For example, the present embodiments may be implemented using a cloud computing system that uses SMS notifications to facilitate the management of personal finances from a set of remote electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating management of a financial transaction, comprising:
obtaining transaction data for a financial transaction between a user and an organization from a Short Message Service (SMS) notification on an electronic device of the user;
determining a category of the financial transaction based on the transaction data;
displaying the transaction data and the category on the electronic device; and
using the displayed transaction data and the displayed category to enable, for the user, management of the financial transaction without accessing the transaction data at the organization.

2. The computer-implemented method of claim 1, wherein obtaining the transaction data for the financial transaction from the SMS notification involves:
scraping the transaction data from the SMS notification.

3. The computer-implemented method of claim 1, wherein the transaction data is obtained upon detecting a delivery of the SMS notification to the electronic device.

4. The computer-implemented method of claim 1, wherein determining the category of the financial transaction based on the transaction data involves:
using a sender identifier from the SMS notification to identify the organization as a sender of the SMS notification; and
identifying the category using the organization and one or more keywords in the SMS notification.

5. The computer-implemented method of claim 4, wherein the sender identifier comprises:
an access provider code;
a service area code; and
an organization identifier.

6. The computer-implemented method of claim 1, wherein the transaction data and the category are displayed to the user using at least one of a list, a chart, a table, and a graphic.

7. The computer-implemented method of claim 1, wherein using the displayed transaction data and the displayed category to enable, for the user, management of the financial transaction involves at least one of:
providing a reminder associated with the financial transaction to the user;
providing a balance associated with the financial transaction and other financial transactions between the user and one or more organizations comprising the organization;
enabling contact between the user and a financial institution associated with the financial transaction;
providing an account history associated with the financial transaction and the other financial transactions; and
enabling tracking of a budget based on the financial transaction and the other financial transactions.

8. The computer-implemented method of claim 1, wherein the financial transaction is at least one of a completed transaction and an upcoming transaction.

9. A system for facilitating management of a financial transaction, comprising:
an analysis apparatus configured to:
obtain transaction data for a financial transaction between a user and an organization from a Short Message Service (SMS) notification on an electronic device of the user; and
determine a category of the financial transaction based on the transaction data; and
a management apparatus configured to:
display the transaction data and the category on the electronic device; and
use the displayed transaction data and the displayed category to enable, for the user, management of the financial transaction without accessing the transaction data at the organization.

10. The system of claim 9, wherein obtaining the transaction data for the financial transaction from the SMS notification involves:
scraping the transaction data from the SMS notification.

11. The system of claim 9, wherein the transaction data is obtained upon detecting a delivery of the SMS notification to the electronic device.

12. The system of claim 9, wherein determining the category of the financial transaction based on the transaction data involves:
using a sender identifier from the SMS notification to identify the organization as a sender of the SMS notification; and
identifying the category using the organization and one or more keywords in the SMS notification.

13. The system of claim 12, wherein the sender identifier comprises:
an access provider code;
a service area code; and
an organization identifier.

14. The system of claim 9, wherein the transaction data and the category are displayed to the user using at least one of a list, a chart, a table, and a graphic.

15. The system of claim 9, wherein using the displayed transaction data and the displayed category to enable, for the user, management of the financial transaction involves at least one of:
providing a reminder associated with the financial transaction to the user;
providing a balance associated with the financial transaction and other financial transactions between the user and one or more organizations comprising the organization;
enabling contact between the user and a financial institution associated with the financial transaction;
providing an account history associated with the financial transaction and the other financial transactions; and
enabling tracking of a budget based on the financial transaction and the other financial transactions.

16. The system of claim 9, wherein the financial transaction is at least one of a completed transaction and an upcoming transaction.

17. A computer-readable storage medium storing instructions that when executed by a computer cause the computer to perform a method for facilitating management of a financial transaction, the method comprising:
obtaining transaction data for a financial transaction between a user and an organization from a Short Message Service (SMS) notification on an electronic device of the user;
determining a category of the financial transaction based on the transaction data;
displaying the transaction data and the category on the electronic device; and
using the displayed transaction data and the displayed category to enable, for the user, management of the financial transaction without accessing the transaction data at the organization.

18. The computer-readable storage medium of claim 17, wherein obtaining the transaction data for the financial transaction from the SMS notification involves:
scraping the transaction data from the SMS notification.

19. The computer-readable storage medium of claim 17, wherein the transaction data is obtained upon detecting a delivery of the SMS notification to the electronic device.

20. The computer-readable storage medium of claim 17, wherein determining the category of the financial transaction based on the transaction data involves:
using a sender identifier from the SMS notification to identify the organization as a sender of the SMS notification; and
identifying the category using the organization and one or more keywords in the SMS notification.

21. The computer-readable storage medium of claim 20, wherein the sender identifier comprises:
an access provider code;
a service area code; and
an organization identifier.

22. The computer-readable storage medium of claim 17, wherein the transaction data and the category are displayed to the user using at least one of a list, a chart, a table, and a graphic.

23. The computer-readable storage medium of claim 17, wherein using the displayed transaction data and the displayed category to enable, for the user, management of the financial transaction involves at least one of:
providing a reminder associated with the financial transaction to the user;
providing a balance associated with the financial transaction and other financial transactions between the user and one or more organizations comprising the organization;
enabling contact between the user and a financial institution associated with the financial transaction;
providing an account history associated with the financial transaction and the other financial transactions; and
enabling tracking of a budget based on the financial transaction and the other financial transactions.

24. The computer-readable storage medium of claim 17, wherein the financial transaction is at least one of a completed transaction and an upcoming transaction.
